(19) United States
(12) Patent Application Publication
(10) Pub. No.: US 2019/0100693 A1
(43) Pub. Date: Apr. 4, 2019

(54) Kind of fluorine nitride fluorescent powder and the light emitting device containing the fluorescent powder

(71) Applicants: Jintian Lin, Shenzhen (CN); Lei Chen, Shenzhen (CN); Jinlan Cai, Shenzhen (CN); Chao Li, Shenzhen (CN)

(72) Inventors: Jintian Lin, Shenzhen (CN); Lei Chen, Shenzhen (CN); Jinlan Cai, Shenzhen (CN); Chao Li, Shenzhen (CN)

(21) Appl. No.: 15/978,178

(22) Filed: May 13, 2018

(30) Foreign Application Priority Data
Mar. 23, 2018 (CN) 2018102471197

(51) Int. Cl. C09K 11/77; C09K 11/08

(52) U.S. Cl. CPC C09K 11/7733; C09K 11/0883

(57) ABSTRACT

This invention involves a kind of fluorine nitride fluorescent powder and the light emitting device containing the fluorescent powder. The chemical formula of fluorescent powder is Rₓ(M_{y},Eu_{z})Alₐ(Si_{b},Ge_{c},Mn_{f})N_{d}Fₑ. In the formula, R is selected from Li, Na and K (at least one element); M is selected from Ca, Sr, Mg and Ba (at least one element); x, y, z, a, b, c and d are the amount of substance of each component, where 0<x≤0.2, 0.9≤y≤1.0, 0.001≤z≤0.1, 0.9≤a≤0.99, 0.8≤b≤1.0, 0≤c≤0.1, 2.5≤d≤3.0, 0.01≤e≤1.2, 0.01≤f≤0.1. In this invention, alkali metal, fluorine element and manganese element are introduced in the fluorescent powder at the same time. The luminous efficiency is high, and the synthetic process is simple. Its structure is same with CaAlSiN₃. The fluorescent powder may be used independently or combined with other fluorescent powder to prepare the light emitting device with high performance.

### TECHNICAL FIELD

This invention relates to inorganic luminescent material field, in particular to fluorescent powder composed of inorganic compounds and its application. To be specific, this invention relates to a kind of fluorine nitride fluorescent powder and the light emitting device containing the fluorescent powder.

### BACKGROUND TECHNOLOGY

White light LED has the advantages of high light efficiency, low energy consumption, long service life and no pollution, so it is widely applied in lighting and display fields. With the rapid development of high-quality lighting and display, LED puts forward higher and higher requirements for lighting effect while pursuing color rendering index. In the implementation process of white light LED, fluorescent powder plays a very important role, and it decides light effect, color temperature and color rendering index of white light LED.

Nitrogen fluorescent powder is mainly studied because of its numerous advantages such as stable physical and chemical properties, wide excitation range, pure and adjustable emission spectrum. Since the preparation conditions of nitrogen fluorescent powder are relatively rigorous, luminance promotion technology still has great space. Intematix Corporation introduced halogen elements to improve fluorescent powder luminance during preparing MAlSiN₃:Eu²⁺(M=Ca,Sr,Ba)nitrogen fluorescent powder (U.S. Pat. No. 8,274,215). Bree Optronics improved light effect through introducing certain amount of alkali metal on the basis of (Ca, Sr) AlSiN₃:Eu²⁺ and balancing the electric charge by tiny amount of oxygen (CN 201310285749.0). this indicates that the introduction of certain alkali metal and halogen element can effectively promote light effect of nitride red powder. K₂TiF₆ and K₂SiF₆ red fluorophors activated by Mn⁴⁺ have the advantages high luminance and narrow half-peak width (U.S. Pat. Nos. 3,576,756, 7,497,973, 7,648,649). Light effect of such material is higher than that of nitride red powder, but its stability is still relatively poor. If the advantages of nitride red powder (good stability) and fluoride red powder (high luminance) can be effectively combined, it will be of great significance for improving light effect of LED.

### Invention Content

To solve the above problem, the purpose of this invention is as follows:

(1) To provide fluorine nitride red fluorescent powder with high luminance and high stability;

(2) To propose the light emitting device containing the fluorescent powder.

The technical proposal provides a kind of fluorine nitride fluorescent powder and the light emitting device containing the fluorescent powder. To be specific,

A kind of fluorine nitride fluorescent powder. Its chemical formula is Rₓ(M_{y},Eu_{z})Alₐ(Si_{b},Ge_{c},Mn_{f})N_{d}Fₑ. In the formula, R is selected from Li, Na and K (at least one element); M is selected from Ca, Sr, Mg and Ba (at least one element); x, y, z, a, b, c and d are the amount of substance of each component, where 0<x≤0.2, 0.9≤y≤1.0, 0.001≤z≤0.1, 0.9≤a≤0.99, 0.8≤b≤1.0, 0≤c≤0.1, 2.5≤d≤3.0, 0.01≤e≤1.2, 0.01≤f≤0.1. Its structure is same with CaAlSiN₃.

Optimally, 0.05≤x≤0.1, 0.9≤y≤0.95, 0.003≤z≤0.05, 0.9≤a≤0.95, 0.9≤b≤1.0, 0.05≤c≤0.1, 2.7≤d≤3.0, 0.15≤e≤0.3, 0.05≤f≤0.1.

Optimally, the said R element is K; M element only contains Ca and Sr.

Optimally, 1.0≤x+y≤1.1, and 9≤y/x≤20.

Optimally, 1.05≤b/a≤1, and 12≤b/c≤18.

Optimally, 4.5≤d/e≤9.5.

Optimally, Sr/Ca in M element is between 5 and 15.

A light emitting device. It includes excitation light source and illuminant. The illuminant contains the above said fluorescent powder.

Optimally, the said excitation light source is ultraviolet or blue light emission source.

The technical proposal also discloses the method to prepare the said fluorescent powder, i.e. high temperature solid state method and hydrothermal method. The preparation steps are as follows: weigh simple substance or compound corresponding elements according to the components of chemical formula; after grinding and mixing evenly, sinter for 4-10 h under 1600° C.˜1800° C. to gain the midbody; crush and post-process the midbody as the precursor of hydrothermal method; use the precursor as the raw material, add some reagents containing corresponding elements, mix them fully and react for 1-5 h; finally, dry to gain the product.

The technical proposal may include the following beneficial effects:

In this invention, alkali metal, fluorine element and manganese element are introduced in the fluorescent powder at the same time. The luminous efficiency is high, and the synthetic process is simple. Its structure is same with CaAlSiN₃. The fluorescent powder may be used independently or combined with other fluorescent powder to prepare the light emitting device with high performance.

The additional aspects and advantages of this invention will be given in the following description, and some will become obvious in the following description or be known through the practice of this invention. We should understand that the above general description and the following detail description are only of example property and explanation property, and cannot restrict this invention.

### DESCRIPTIONS OF ATTACHED FIGURES

Attached figures are used to further explain this invention, but the implementation examples in the attached figures do not form any restriction of this invention. For common technical personnel in this field, other attached figures may be gained according to the following attached figures under the precondition of no any creative labor.

FIG. 1 shows the excitation light and emission spectrum in Implementation Example 1;

FIG. 2 shows XRD spectrum in Implementation Example 1.

### DETAILED IMPLEMENTATION WAY

Next, the implementation examples are further enumerated to describe this invention in detail. Similarly, we should understand the following implementation examples are only used to further explain the invention, and cannot be understood as the restriction of protection scope of this invention. Some non-essential improvements and adjustments made by technical personnel in this field according to the above content of his invention belong to the protection scope of this invention. The specific technological parameters in the following examples are only suitable for one example in the scope. In other words, the technical personnel in this field may make a choice in the appropriate scope based on the description here, and may not be limited to the specific values in the following examples.

### Implementation Example 1

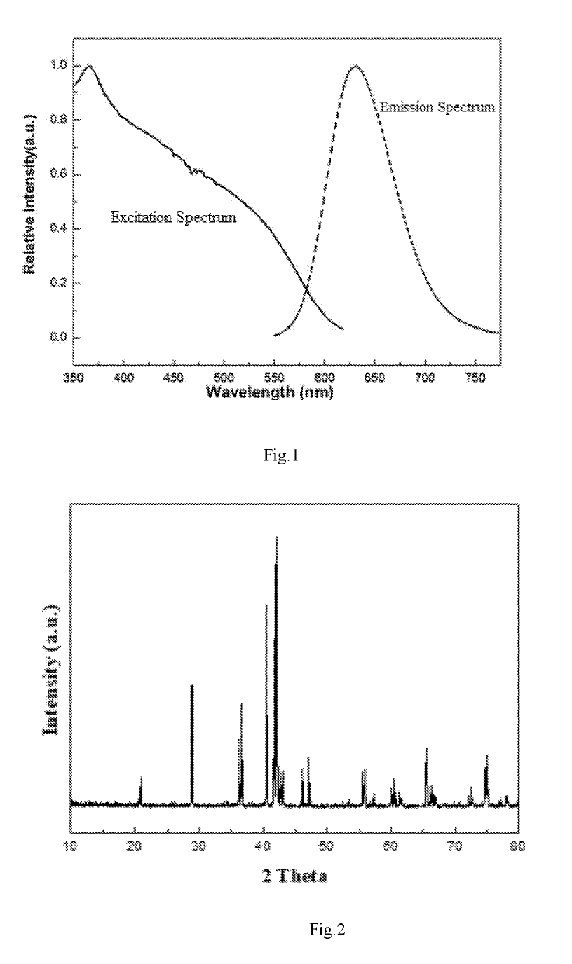

Implementation example 1 In the chemical formula K_{0.1}Ca_{0.886}Eu_{0.004}Al_{0.9}Si_{0.95}Mn_{0.01}N_{2.7}F_{0.3}, weigh compound of calcium metal, nitride of aluminium metal, nitride of silicon metal and compound of europium metal according to the stoichiometric ratio; after mixing them evenly, sinter for 8 h under 1600° C. to gain the midbody; crush and post-process the midbody as the precursor of hydrothermal method; add fluoride of potassium metal, compound of silicon metal and compound of manganese metal, and conduct hydrothermal mixing for 4 h; after drying under 90° C., dry the surface to gain the product. Fluorescence luminescence characteristics of the product are shown in Tab.1. The emission spectrum is shown in FIG. 1.

### Implementation Examples 2˜15

In the chemical formula Rₓ(M_{y},Eu_{z})Alₐ(Si_{b},Ge_{c},Mn_{f})N_{d}Fₑ, R is selected from Li, Na and K (at least one element); M is selected from Ca, Sr, Mg and Ba (at least one element); x, y, z, a, b, c, d, e and f are the amount of each component. The compounds of corresponding elements are weighed according to the different chemical components. The preparation process is same with Implementation example 1. Fluorescence luminescence characteristics of the product are shown in Tab.1.

TABLE 1
Luminescence characteristics of fluorescent powder

| | | Rela- |
|---|---|---|
| Implemen- | | tive |
| tation | | inten- |
| example | Chemical formula | sity |
| 1 | K_{0.1}Ca_{0.886}Eu_{0.004}Al_{0.9}Si_{0.95}Mn_{0.01}N_{2.7}F_{0.3} | 100 |
| 2 | K_{0.1}Sr_{0.886}Eu_{0.004}Al_{0.9}Si_{0.95}Mn_{0.01}N_{2.7}F_{0.3} | 83 |
| 3 | K_{0.1}Ba_{0.886}Eu_{0.004}Al_{0.9}Si_{0.95}Mn_{0.01}N_{2.7}F_{0.3} | 73 |
| 4 | K_{0.1}Mg_{0.886}Eu_{0.004}Al_{0.9}Si_{0.95}Mn_{0.01}N_{2.7}F_{0.3} | 80 |
| 5 | Li_{0.1}Ca_{0.886}Eu_{0.004}Al_{0.9}Si_{0.95}Mn_{0.01}N_{2.7}F_{0.3} | 98 |
| 6 | Na_{0.1}Ca_{0.886}Eu_{0.004}Al_{0.9}Si_{0.95}Mn_{0.01}N_{2.7}F_{0.3} | 91 |
| 7 | K_{0.1}Ca_{0.1}Sr_{0.85}Eu_{0.001}Al_{0.9}Si_{0.95}Mn_{0.01}N_{2.7}F_{0.3} | 125 |
| 8 | K_{0.1}Ca_{0.1}Sr_{0.85}Eu_{0.003}Al_{0.9}Si_{0.95}Mn_{0.01}N_{2.7}F_{0.3} | 131 |
| 9 | K_{0.1}Ca_{0.1}Sr_{0.85}Eu_{0.01}Al_{0.9}Si_{0.95}Mn_{0.01}N_{2.7}F_{0.3} | 135 |
| 10 | K_{0.1}Ca_{0.1}Sr_{0.85}Eu_{0.05}Al_{0.9}Si_{0.95}Mn_{0.01}N_{2.7}F_{0.3} | 140 |
| 11 | K_{0.1}Ca_{0.1}Sr_{0.85}Eu_{0.1}Al_{0.9}Si_{0.95}Mn_{0.01}N_{2.7}F_{0.3} | 122 |
| 12 | K_{0.2}Ca_{0.1}Sr_{0.8}Eu_{0.04}Al_{0.9}Si_{0.95}Mn_{0.01}N_{2.52}F_{0.6} | 132 |
| 13 | K_{0.05}Ca_{0.1}Sr_{0.8}Eu_{0.04}Al_{0.9}Si_{1.0}Mn_{0.01}N₃F_{0.15} | 125 |
| 14 | K_{0.1}Ca_{0.1}Sr_{0.83}Eu_{0.05}Al_{0.9}Si_{1.05}Ge_{0.1}Mn_{0.01}N_{2.7}F_{0.3} | 139 |
| 15 | K_{0.1}Ca_{0.1}Sr_{0.83}Eu_{0.05}Al_{0.9}Si_{1.0}Ge_{0.05}Mn_{0.01}N_{2.7}F_{0.3} | 142 |
| 16 | K_{0.1}Ca_{0.1}Sr_{0.83}Eu_{0.05}Al_{0.9}Si_{0.96}Ge_{0.08}Mn_{0.01}N_{2.7}F_{0.3} | 144 |
| 17 | K_{0.1}Ca_{0.1}Sr_{0.83}Eu_{0.05}Al_{0.9}Si_{1.08}Ge_{0.06}Mn_{0.01}N_{2.7}F_{0.3} | 143 |
| 18 | K_{0.08}Ca_{0.1}Sr_{0.83}Eu_{0.05}Al_{0.98}Si_{1.0}Ge_{0.05}Mn_{0.01}N_{2.7}F_{0.24} | 138 |
| 19 | K_{0.2}Ca_{0.1}Sr_{0.8}Eu_{0.04}Al_{0.94}Si_{1.1}Mn_{0.01}N_{2.5}F_{1.2} | 135 |
| 20 | K_{0.033}Ca_{0.1}Sr_{0.83}Eu_{0.04}Al_{0.93}Si_{1.1}Mn_{0.01}N_{2.5}F_{0.01} | 123 |
| 21 | K_{0.1}Ca_{0.1}Sr_{0.84}Eu_{0.05}Al_{0.99}Si_{1.08}Ge_{0.06}Mn_{0.01}N_{2.7}F_{0.3} | 145 |
| 22 | K_{0.04}Ca_{0.1}Sr_{0.8}Eu_{0.05}Al_{0.9}Si_{0.8}Ge_{0.06}Mn_{0.06}N_{2.7}F_{0.12} | 127 |
| 23 | K_{0.04}Ca_{0.1}Sr_{0.9}Eu_{0.05}Al_{0.9}Si_{1.08}Ge_{0.06}Mn_{0.01}N_{2.7}F_{0.12} | 134 |
| 24 | K_{0.05}Ca_{0.1}Sr_{0.9}Eu_{0.04}Al_{0.9}Si_{1.0}Mn_{0.01}N₃F_{0.15} | 139 |
| 25 | K_{0.1}Ca_{0.1}Sr_{0.83}Eu_{0.05}Al_{0.9}Si_{0.99}Ge_{0.06}Mn_{0.01}N_{2.94}F_{0.3} | 146 |
| 26 | K_{0.1}Ca_{0.1}Sr_{0.83}Eu_{0.05}Al_{0.9}Si_{0.945}Ge_{0.06}Mn_{0.01}N_{2.94}F_{0.3} | 143 |
| 27 | K_{0.1}Ca_{0.1}Sr_{0.83}Eu_{0.05}Al_{0.9}Si_{0.98}Ge_{0.06}Mn_{0.01}N_{2.94}F_{0.3} | 145 |
| 28 | K_{0.1}Ca_{0.1}Sr_{0.83}Eu_{0.05}Al_{0.9}Si_{0.99}Ge_{0.06}Mn_{0.03}N_{2.94}F_{0.3} | 149 |
| 29 | K_{0.1}Ca_{0.1}Sr_{0.83}Eu_{0.05}Al_{0.9}Si_{0.99}Ge_{0.06}Mn_{0.05}N_{2.94}F_{0.3} | 146 |
| 30 | K_{0.1}Ca_{0.1}Sr_{0.83}Eu_{0.05}Al_{0.9}Si_{0.99}Ge_{0.06}Mn_{0.08}N_{2.94}F_{0.3} | 135 |
| 31 | K_{0.1}Ca_{0.1}Sr_{0.83}Eu_{0.05}Al_{0.9}Si_{0.99}Ge_{0.06}Mn_{0.1}N_{2.94}F_{0.3} | 130 |

What are described above are just the good implementation examples of this invention. They are not used to restrict this invention. Any modification, equivalent replacement and improvement under the spirit and principle of this invention should be included in the protection range of this invention.

1. A kind of fluorine nitride fluorescent powder, characterized by that its chemical formula is:
K_{0.1}Ca_{0.1}Sr_{0.83}Eu_{0.05}Al_{0.9}Si_{1.0}Ge_{0.05}Mn_{0.01}N_{2.7}F_{0.3} or K_{0.1}Ca_{0.1}Sr_{0.83}Eu_{0.05}Al_{0.9}Si_{0.96}Ge_{0.08}Mn_{0.01}N_{2.7}F_{0.3}
or K_{0.1}Ca_{0.1}Sr_{0.83}Eu_{0.05}Al_{0.9}Si_{1.08}Ge_{0.06}Mn_{0.01}N_{2.7}F_{0.3} or
K_{0.1}Ca_{0.1}Sr_{0.83}Eu_{0.05}Al_{0.9}Si_{0.99}Ge_{0.06}Mn_{0.01}N_{2.94}F_{0.3} or
K_{0.1}Ca_{0.1}Sr_{0.83}Eu_{0.05}Al_{0.9}Si_{0.945}Ge_{0.06}Mn_{0.01}N_{2.94}F_{0.3} or
K_{0.1}Ca_{0.1}Sr_{0.83}Eu_{0.05}Al_{0.9}Si_{0.98}Ge_{0.06}Mn_{0.01}N_{2.94}F_{0.3} or
K_{0.1}Ca_{0.1}Sr_{0.83}Eu_{0.05}Al_{0.9}Si_{0.99}Ge_{0.06}Mn_{0.03}N_{2.94}F_{0.3} or
K_{0.1}Ca_{0.1}Sr_{0.83}Eu_{0.05}Al_{0.9}Si_{0.99}Ge_{0.06}Mn_{0.05}N_{2.94}F_{0.3}.

2. A light emitting device, comprising an excitation light source and an illuminant, wherein said illuminant includes the fluorescent powder of claim 1.

3. The light emitting device of claim 2, wherein said excitation light source is ultraviolet or blue light emission source.
